(19) United States
(12) Patent Application Publication
(10) Pub. No.: US 2024/0235025 A1
(43) Pub. Date: Jul. 11, 2024

(54) VEHICLE ANTENNA RADIATOR ARRANGEMENT INTEGRATED WITH VEHICLE GLAZING

(71) Applicant: JAGUAR LAND ROVER LIMITED, Whitley, Coventry, Warwickshire (GB)

(72) Inventors: Shaozhen ZHU, Coventry, Warwickshire (GB); Emma KOWALCZUK, Coventry, Warwickshire (GB)

(21) Appl. No.: 18/285,378

(22) PCT Filed: Mar. 31, 2022
(86) PCT No.: PCT/EP2022/058681

§ 371 Date: Oct. 2, 2023

(30) Foreign Application Priority Data
Mar. 31, 2021 (GB) 2104581.0

(51) Int. Cl. H01Q 5/371; H01Q 1/12; H01Q 1/32; H01Q 9/42

(52) U.S. Cl. CPC H01Q 5/371; H01Q 1/1271; H01Q 1/325; H01Q 9/42

(57) ABSTRACT

A vehicle antenna apparatus (12) comprising:
a feed point (FP); and
a radiator arrangement (20) configured to be integrated with vehicle glazing (30);
wherein the radiator arrangement comprises a branch (204, 206) configured to resonate in a first operational frequency band.

### TECHNICAL FIELD

The present disclosure relates to a vehicle antenna radiator arrangement integrated with vehicle glazing. In particular, but not exclusively the vehicle antenna radiator arrangement is operated as a transceiver or transmitter.

### BACKGROUND

Vehicles are increasingly requiring several antennas to meet growing consumer expectations for connectivity. The connectivity can include streaming music, videos, receiving over-the-air software updates for the vehicle, security features and much more. New Radio Access Technologies allow the exchange of more data in parallel, making it feasible for customers to receive more services as they travel in the vehicle.

Antennas can be distributed at multiple locations around the vehicle, to increase MIMO (multiple-input, multiple-output) capability and reduce mutual coupling of antenna elements.

A vehicle will typically comprise a roof pod, also referred to as a ‘shark fin’, comprising one or more transceiver or transmitter antennas. However, a roof pod does not create the desired image of a sleek vehicle body shape and can adversely affect vehicle aerodynamic performance.

### SUMMARY OF THE INVENTION

It is an aim of the present invention to provide an improved antenna apparatus. The invention is as defined in the appended independent claims.

According to an aspect of the invention there is provided a vehicle antenna apparatus comprising: a feed point; and a radiator arrangement configured to be integrated with vehicle glazing; wherein the radiator arrangement comprises a branch configured to resonate in a first operational frequency band.

An advantage of the glazing integration is that a roof pod may no longer be needed. Further, the branch(es) reduce the height of the radiator arrangement to prevent driver vision obscuration, without compromising antenna performance.

In some examples, the apparatus comprises circuitry configured to operate the vehicle antenna apparatus as a transceiver or as a transmitter. In some examples, the first operational frequency band is at least 0.6 GHz. This enables cellular services, for example.

In some examples, the circuitry is configured to electrically connect to the radiator arrangement via the feed point and is configured to electrically connect to a ground plane that is not integrated with the vehicle glazing. This enables a large ground plane.

In some examples, the radiator arrangement is a planar radiator arrangement. In some examples, the radiator arrangement is a printed radiator arrangement. This enables a lightweight apparatus.

In some examples, the apparatus comprises an adhesive patch, the adhesive patch comprising the radiator arrangement. In some examples, the adhesive patch and the radiator arrangement are configured to be flexible enough to enable the radiator arrangement to be coplanar with curved vehicle glazing.

In some examples, the radiator arrangement comprises a column and the branch together forming a T-shape. In some examples, the branch is substantially symmetrical about the column. In some examples, the branch comprises an inner branch and an outer branch. In some examples, the outer branch wraps around the inner branch.

In some examples, the radiator arrangement comprises a slot shaped to demarcate the branch into the inner branch and the outer branch. In some examples, the slot is a closed slot so that the inner branch is electrically connected to the outer branch.

In some examples, the branch is a first branch and wherein the vehicle antenna apparatus comprises a second branch configured to resonate in a second operational frequency band.

In some examples, the second operational frequency band is greater than the first operational frequency band. In some examples, the branch is distal from the feed point and the second branch is proximal to the feed point. In some examples, the second branch is towards an opposite end of the column than the first branch. In some examples, the second branch is folded.

According to an aspect of the invention there is provided a system comprising the vehicle antenna apparatus, and a vehicle glazing panel comprising the radiator arrangement of the vehicle antenna apparatus.

In some examples, the vehicle glazing panel is laminated, and wherein the radiator arrangement is laminated between glazing layers of the laminated vehicle glazing panel.

In some examples, the vehicle glazing panel comprises a reflective layer configured to cover a substantial portion of the vehicle glazing panel to reflect infrared radiation, wherein the reflective layer comprises a gap around the location of the vehicle antenna apparatus.

According to an aspect of the invention there is provided a vehicle comprising the vehicle antenna apparatus, or the system.

In some examples, the vehicle comprises a ground plane for the vehicle antenna apparatus.

In some examples, the ground plane is oriented approximately along a vehicle body panel, wherein the radiator arrangement extends along the vehicle glazing panel, the vehicle glazing panel being at a rake angle relative to the vehicle body panel such that an internal angle between the radiator arrangement and the ground plane is greater than 90 degrees.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of a system comprising a vehicle antenna apparatus and a glazing panel;

FIG. 3 illustrates an example of a radiator arrangement;

FIGS. 4A and 4B each illustrate an example of a system comprising a radiator arrangement and a glazing panel;

FIG. 5 illustrates an example of an adhesive patch;

FIG. 6 illustrates an example of a glazing panel with a reflective layer and a radiator arrangement;

FIG. 7 illustrates example locations for the radiator arrangement;

FIG. 8 illustrates an example graph of S11 parameters for a simulation of a radiator arrangement in-situ on a vehicle;

FIG. 9 illustrates an example simulated radiation efficiency graph; and

FIG. 10 illustrates an example graph of S11 parameters for different ground plane angles.

### DETAILED DESCRIPTION

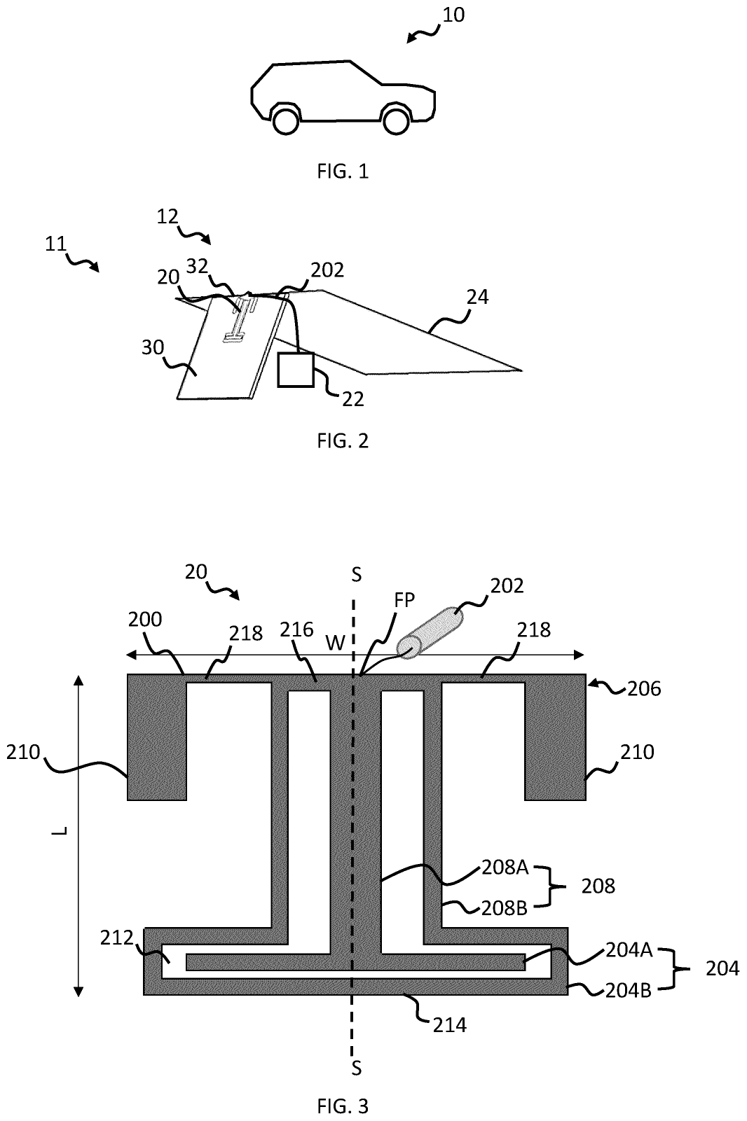

FIG. 1 illustrates an example of a vehicle 10 in which embodiments of the invention can be implemented. In some, but not necessarily all examples, the vehicle is a passenger vehicle, also referred to as a passenger car or as an automobile. In other examples, embodiments of the invention can be implemented for other applications, such as commercial vehicles.

FIG. 2 illustrates a system 11 comprising a vehicle antenna apparatus 12 and a vehicle glazing panel 30. The glazing panel 30 can be a front window, a rear window, a side window or a sunroof window of the vehicle 10.

The vehicle antenna apparatus 12 comprises a radiator arrangement 20 which is integrated with the glazing panel 30. The radiator arrangement 20 is located towards a periphery of the glazing panel 30. The radiator arrangement 20 may abut or nearly abut against a peripheral edge 32 of the glazing panel 30. The radiator arrangement 20 comprises at least one folded branch to reduce its protrusion towards a centre of the glazing panel 30, relative to a quarter-wavelength monopole. The radiator arrangement 20 comprises a few branches to achieve multiple radiation bands coverage at cellular frequencies.

The vehicle antenna apparatus 12 of FIG. 2 additionally comprises circuitry 22 and a feed 202 operably coupling the circuitry 22 to the radiator arrangement 20. The feed 202 can comprise a coaxial cable or similar. The circuitry 22 may or may not be secured to the glazing panel 30. In the illustration, the circuitry 22 is not secured to the glazing panel 30.

The circuitry 22 can be operably coupled to a vehicle infotainment system (not shown), so that when a user connects their personal cellular device (e.g. hand-portable electronic device such as mobile phone) to the vehicle infotainment system, the user's personal device is able to leverage the capabilities of the vehicle antenna apparatus 12. The connection to the vehicle infotainment system can be via a wired connection or via a wireless personal area connection, or similar. Additionally, or alternatively, the vehicle antenna apparatus 12 can connect to a cellular subscriber identity module integrated with the vehicle 10, or even to a non-cellular device.

The circuitry 22 can be configured to operate the glazing-integrated vehicle antenna apparatus 12 as a transceiver or as a transmitter. This enables the requesting of data for access to two-way communication services such as the Internet. The circuitry 22 can comprise driving circuitry for transmission. The circuitry can comprise reception circuitry for reception. The circuitry 22 can comprise an oscillator circuit, a modulator/demodulator circuit, an amplifier, and impedance matching circuitry, for example.

The vehicle antenna apparatus 12 of FIG. 2 additionally comprises a ground plane 24. A ground plane 24 comprises a large area of conductive material such as metal. The ground plane 24 may be implemented either by a vehicle body panel such as the vehicle roof panel, or by a separate conductive sheet. In examples, the ground plane 24 is not secured to the glazing panel 30.

The illustrated ground plane 24 is parallel to a vehicle roofline or similar upper body panel of the vehicle 10. Therefore, an internal angle between the ground plane 24 and the radiator arrangement 20 can be greater than 90 degrees due to the near-vertical orientation of the glazing panel 30. The internal angle can be greater than 110 degrees if the glazing panel 30 is substantially raked, such as a front windshield. Example dimensions are provided later.

FIG. 3 illustrates the shape of an example radiator arrangement 20 of the vehicle antenna apparatus 12. The radiator arrangement 20 can be substantially planar as shown in later Figures. According to the example, more than one branch 204, 206 can be provided. According to the example, at least one of the branches 204, 206 can be folded. According to the example, at least one of the branches 204 can comprise an inner branch 204A and an outer branch 204B.

Note that the terms “branch” and “fold” as used in antenna design refer to different geometric features. A fold refers to a direction change, typically a planar direction change, of a trace. A branch refers to a portion that has been split into two or more directions from a stem/column, such as a top hat of a T-antenna.

The geometry is described below, referencing a length dimension and a width dimension. The length dimension is the dimension extending away from the feed 202 and away from the peripheral edge 32 of the glazing panel 30. The width dimension is perpendicular to the length dimension and extends parallel to the peripheral edge 32 of the glazing panel 30.

The radiator arrangement 20 comprises electrically conductive trace material forming a first branch 204 and a second branch 206 interconnected to each other by a central column 208. The branches 204, 206 can be approximately perpendicular to the column 208. In another example, one of the branches 204, 206 can be omitted. The branches 204, 206 extend in the width dimension. The column 208 extends in the length dimension. The column 208 can be centred and extending coaxially with a line of symmetry S of the radiator arrangement 20. The electrically conductive material can comprise copper, aluminium or an optically transparent conductive metal. Examples of optically transparent conductive materials include transparent conductive ink/paint, or a same material as an infrared-radiation reflective (IRR) film that may cover other portions of the glazing.

In this description the first branch 204 refers to the branch that is distal from the feed 202 and the second branch 206 refers to the branch that is proximal to the feed 202. In this description ‘bottom’ refers to the edge closest to the feed 202 and closest to the peripheral edge 32 of the glazing panel 30, whereas ‘top’ refers to the opposite edge from the bottom edge, furthest from the feed 202.

The illustrated feed 202 connects to the second branch 206. For example, the feed 202 can connect to a bottom edge 200 of the radiator arrangement 20 as shown, the bottom edge 200 defining a bottom edge of the second branch 206. The bottom edge 200 extends in the width dimension and is closest to the peripheral edge 32 of the glazing panel 30 when installed.

The branches can be symmetric about the line of symmetry S and therefore about the column 208.

A feed point FP connecting the feed 202 to the radiator arrangement 20 can also be on this line of symmetry S, on or proximal to the bottom edge 200.

The first branch 204 is configured to resonate in an operational frequency band less than 1 GHz. The second branch 206 is configured to resonate in an operational frequency band greater than 1 GHZ. In other words, the inclusion of the first branch 204 targets improved low frequency (<1 GHZ) performance, and the inclusion of the second branch 206 targets improved high frequency (>1 GHZ) performance. The branches 204, 206 can be arranged to enable performance similar to a straight monopole, while minimising the length and width dimensions of the radiator arrangement 20.

An operational frequency band (operational bandwidth) is a frequency range over which an antenna can efficiently operate. An operational frequency band may be defined as where the reflection coefficient S11 of an antenna is less than an operational threshold T such as, for example, −6 dB and where a radiation efficiency is greater than an operational threshold such as for example −1.5 dB in an efficiency plot. Radiation efficiency is the ratio of the power delivered to the radiation resistance of the antenna (Rrad) to the total power delivered to the antenna: er=(Rrad)/(RL+Rrad), where RL=loss resistance (which covers dissipative losses in the antenna itself). It should be understood that “radiation efficiency” does not include power lost due to poor VSWR (mismatch losses in the matching network which is not part of the antenna as such, but an additional circuit). The “total radiation efficiency” comprises the “radiation efficiency” and power lost due to poor VSWR [in dB]. The efficiency operational threshold could alternatively be expressed in relation to “total radiation efficiency” rather than “radiation efficiency”. The threshold for total radiation efficiency can also be −3 dB.

The vehicle antenna apparatus 12 may be configured as a multi-band device to resonate efficiently over several frequency bands covering a wide range. The range can include frequency bands that exist between approximately 800 MHz and approximately 2.6 GHz, or between 600 MHz to 3 GHZ.

In an example, the vehicle antenna apparatus 12 can be configured to support penta-band operation to cover 700 MHz, 900 MHz, 1.8 GHZ, 2.1 GHZ and 2.6 GHz frequency bands, for cellular radio access. The width of each band depends on implementation but can be ±0.1 GHZ, for example.

In some examples, bands higher than 2.6 GHZ and towards at least 6 GHz can be provided, for future 5G implementations.

The multi-band operation can be enabled via the described radiator arrangement 20, without the need for additional radiators. The radiator arrangement 20 of FIG. 3 enables quad-band or penta-band operation, however, aspects of its design or geometry can be altered or omitted if fewer bands is acceptable, or if different frequencies are selected.

The length L of the radiator arrangement 20 can be a value from the range approximately λ/10 to approximately λ/20, where λ is wavelength. In an example, the length L is approximately λ/12.5, where λ=500 mm (f=600 MHz), so L=40 mm. The length can be from the bottom edge 200 to a top edge 214, the top edge 214 being the edge extending along the width dimension that is furthest from the feed 202. The top edge of the first branch 204 can be the top edge 214 of the radiator arrangement 20.

The width W of the radiator arrangement 20 can be a value from the range approximately λ/8 to approximately λ/15. In an example, the width W is approximately λ/9, where λ=500 mm (f=600 MHz), so W=55 mm. The width W can be the width of the bottom edge 200.

The above compact dimensions mean that the radiator arrangement 20 is not visually distracting and is unlikely to enter a driver's field of view, when the radiator arrangement 20 is located adjacent a peripheral edge 32 of the glazing panel 30.

In order to further facilitate high-performance multi-band operation, the illustrated first branch 204 (distal branch) has been demarcated into an inner branch 204A (interior branch) and an outer branch 204B (exterior branch). To enable this, the branch 204 can comprise an interior slot 212 (internal void/hollow) that is folded multiple times in-plane to follow a path (e.g., rectilinear path as shown), wherein the conductive trace to the interior of said slot 212 is an inner branch 204A that connects to the feed 202 via an inner column 208A, and wherein the conductive trace to the exterior of said slot is an outer branch 204B that connects to the same feed 202 via an outer column 208B. The illustrated slot 212 is a continuous, constant width, capacitive gap between the outer branch 204B and the inner branch 204A. At no point do the inner branch 204A and the outer branch 204B make conductive contact with each other.

The outer branch 204B wraps (loops) around and encapsulates the inner branch 204A, following a rectilinear path in the example. In the same manner, the slot 212 wraps (loops) around and encapsulates the inner branch 204A. The inner branch 204A can be a straight conductive trace, perpendicular to the column 208. The outer branch 204B therefore has a longer electrical length than the inner branch 204A, for example, more than double the electrical length.

The column 208 can also be demarcated into an inner column 208A and an outer column 208B, respectively connected to the inner branch 204A and the outer branch 204B. The column 208 can be slotted, for example, by the same slot 212 being folded to extend from the first branch 204 and down the column 208, to each side of the line of symmetry S. The slot 212 therefore demarcates the column 208 into the inner and outer columns 208A, 208B. At no point do the inner column 208A and the outer column 208B make conductive contact with each other.

The inner column 208A can be central, extending straight, and extending coaxially with and bisected by the line of symmetry S. The outer column 208B can be described as a pair of electrical traces parallel to the inner column 208A and separated by the capacitive gap formed by the slot 212.

Based on the above description and FIG. 3, two electrical lengths are defined in relation to the column and first branch:

$$\begin{matrix}Inner = 1 x the length of the inner column + the length of the inner branch . & 1 ) \\ Outer = 1 x the length of the outer column + the length of the outer branch ; & 2 )\end{matrix}$$

The second (outer) electrical length can be more than double the first (inner) electrical length. The second electrical length can be less than triple the first electrical length.

The different electrical lengths capacitively separated by the slot 212 enable a wide bandwidth at sub-1 GHz frequencies.

The above-described slot 212 is folded into a T-shape as illustrated in FIG. 3, wherein the inner branch+column 204A, 208A is to the interior of the slot 212 and forms an interior T-shape (due to the shape of the slot 212), and wherein the outer branch+column 204B, 208B is to the exterior of the slot 212 and forms a hollow T-shape 204B, 208B that wraps around the interior T-shape 204A, 208A. The combination can be described as a pair of nested T-shapes. The exact shape could differ for some implementations.

The illustrated slot 212 is a closed slot, closed at its ends by a bridging portion 216 of conductive material electrically connecting the base of the inner column 208A to the base of the outer column 208B. The ‘base’ means where the columns 208A, 208B meet the bottom edge 200 of the radiator arrangement 20, adjacent the feed point FP.

The bridging portion 216 means that both the outer and inner electrical lengths described above are connected to the same feed 202. The bridging portion 216 also means that the slot 212 is fully enclosed by the outer column 208B and outer branch 204B. The bridging portion 216 can be considered part of the bottom edge 200 of the radiator arrangement 20. A bridging portion 216 is provided at each side of the line of symmetry S.

In the example of FIG. 3, but not necessarily in all examples, the width of the slot 212 can be nonuniform to control the size of a capacitive gap that affects resonance. For example, the illustrated slot 212 has a first average/constant width separating the inner column 208A and the outer column 208B, and a second average/constant width separating the inner branch 204A and the outer branch 204B. The first width is illustrated as greater than the second width.

In the example of FIG. 3, but not necessarily all examples, the widths of the conductive traces defining the column/branches can be nonuniform. For example, the illustrated inner column 208A has an enlarged trace width, compared with the trace widths of one or more of the outer branch 204B, the outer column 208B and the inner branch 204A. The latter may have approximately the same trace widths as each other. The trace width can be configured to tune impedance of the antenna to improve matching performance.

Referring now to the second branch 206, the illustrated second branch 206 is provided by the bottom edge 200 extending in the width dimension past the base of the outer column 208B, for a required distance. It can be said that the second branch 206 connects to the base of the outer column 208B, representing a continuation of the bridging portion 216. The second branch 206 can be symmetrical about the line of symmetry S.

In the example of FIG. 3, but not necessarily in all examples, the second branch 206 differs from the first branch 204. The second branch 206 does not comprise a slot. However, the second branch 206 does comprise a fold 210 (folded portion) that increases its electrical length without increasing the physical width of the radiator arrangement 20 as defined by the extent of the bottom edge 200.

The second branch 206 can be folded upwards (towards the first branch 204 and away from the bottom edge 200). The fold 210 can be symmetrical about the line of symmetry S. The fold 210 can extend parallel to the column 208. The fold 210 can form a perpendicular angle with respect to the unfolded part 218/bottom edge 200 of the second branch 206.

The fold 210 can comprise an enlarged surface area, with a greater trace width than that of the unfolded part 218 of the second branch 206. The trace width can be configured to tune impedance of the antenna to improve matching performance.

In the illustration, the first branch 204 is not folded whereas the second branch 206 is folded. In other examples, the first branch 204 can be folded or both branches can be folded.

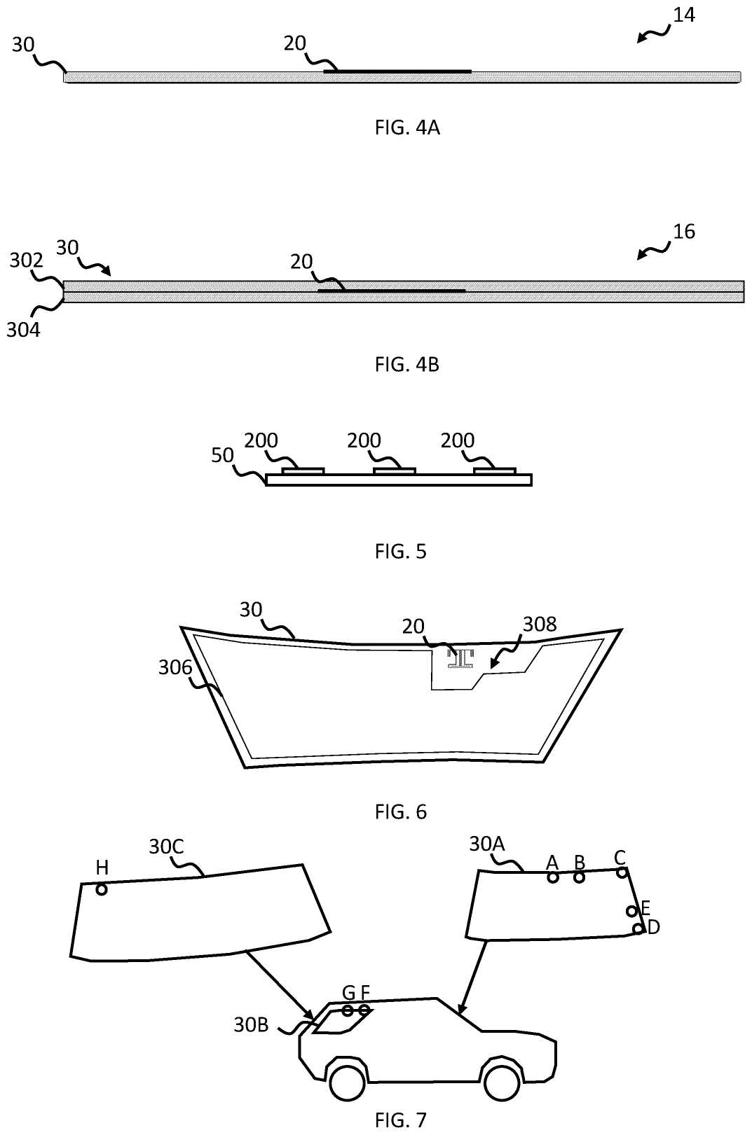

FIGS. 4A-4B illustrate examples of how the radiator arrangement 20 can be integrated with a glazing panel 30. According to the system of FIG. 4A, the radiator arrangement 20 is adhered to a surface of the glazing panel 30 via any appropriate long-lasting adhesive. The surface can comprise an interior surface or an exterior surface of the glazing panel 30.

According to the system of FIG. 4B, the glazing panel 30 is laminated, and the radiator arrangement 20 is laminated between glazing layers 302, 304 of the laminated glazing panel 30. More lamination layers could be provided than the two layers shown.

FIG. 5 illustrates a cross-section of the radiator arrangement 20. The radiator arrangement 20 can be printed onto a substrate 50. A conductive printing technique can be used, or any other appropriate technique. This enables fast, low-cost fabrication with reduced material usage and minimal impact on vehicle weight. The resulting radiator arrangement 20 is substantially planar.

In some examples, the substrate 50 comprises an adhesive patch. In other examples, the radiator arrangement 20 is printed directly onto the glazing panel 30 so the substrate comprises the glazing panel.

The adhesive patch 50 can comprise a flexible polymeric material or similar elastic material configured to be flexible enough to enable the radiator arrangement 20 to be coplanar with a curved glazing panel 30.

FIG. 6 illustrates a glazing panel 30 having a reflective layer 306 configured to cover a substantial portion of the glazing panel 30 and to reflect infrared radiation. The reflective layer 306 may comprise an infrared-radiation reflective (IRR) film. Such films can, however, reflect radio waves. Therefore, the reflective layer 306 can comprise a gap 308 around the location of the radiator arrangement 20, to reduce inefficiency.

The gap can comprise notch or cutout. If the gap is enlarged, the average gain of the vehicle antenna apparatus 12 is increased, with the maximum average realised gain (dBi) being achieved by complete removal of the reflective layer 306. However, the drop in gain associated with the reflective layer 306 was tested and found to be small and acceptable, so the reflective layer 306 with the gap can be included.

FIG. 7 illustrates a non-limiting set of possible locations for the radiator arrangement 20, that provide high average gain at 0-10° elevation and a low percentage below −10 dB, for frequency bands between 0.8 and 2.6 GHz. It would be appreciated that the best locations can vary depending on the vehicle geometry. The locations include:
A—top centre of front windscreen glazing panel 30A;
B—top of front windscreen glazing panel 30A, offset from centre;
C—top corner of front windscreen glazing panel 30A;
D—bottom corner of front windscreen glazing panel 30A;
E—side of front windscreen glazing panel 30A, bottom half;
F—top corner of side-facing rear quarter glazing panel 30B;
G—top centre of side-facing rear quarter glazing panel 30B; and
H—top corner of the rear window/backlite 30C.

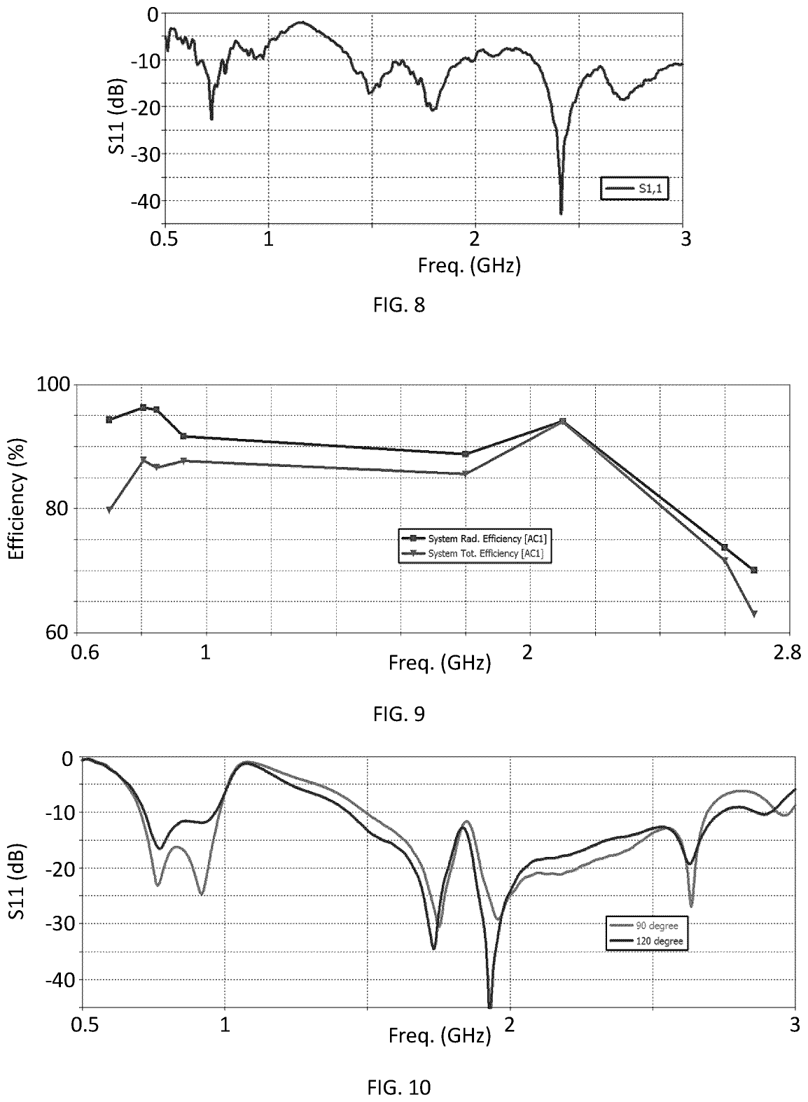

Locations C and G provided the highest gains. FIG. 8 is a graph showing the S11 parameters for location C. The graph was produced by simulating the radiator arrangement 20 in-situ on a sports utility model-shaped vehicle. The graph shows that good impedance matching has been achieved. An operating frequency band with a −6 dB S11 has been achieved from 600 MHz to 960 MHz, 1.7 GHz to 2.7 GHZ. In addition, the average 0-10 degree elevation realised gain was between −2.5 dBi and −3.3 dBi at frequencies between 806 MHz and 2.6 GHz. The radiation pattern showed good omnidirectionality, with the percentage of realised gain level below −10 dB rising from 1.1% towards 7.8% as frequencies increased from 806 MHz to 2.6 GHz.

All of the other locations except location H had similar results for the same frequencies. Their average realised gains were all better than −5 dBi, and their percentages below −10 dB were all better than 13%. Radiated efficiencies were at least 80% or better. It is expected that location H will be in line with the other locations if the rear windshield heating elements are distanced from the radiator arrangement 20.

FIG. 9 is a graph illustrating simulated radiation performance for the radiator arrangement 20 shown in FIG. 3 (L=40 mm, W=55 mm), on a glass glazing panel that is perpendicular to a ground plane (ground plane=200 mm×600 mm). The rest of the vehicle was not part of this simulation, and the purpose was to investigate the inherent characteristics of the antenna apparatus. The relative permittivity of the glass was within the range 4 to 6, and the glass thickness was within the range 3 mm to 5 mm.

The graph illustrates that both radiated efficiency and total radiated efficiency are better than 80% below 2.2 GHz. At 2.6 GHz, the efficiency is above 60%.

The simulations varied the parameters and found that:
with glass permittivity increase, the antenna impedance band was shifted downwards by 20 MHz per 0.2 increase, and a change in antenna gain is only obvious at 2.6 GHz when permittivity is more than 5.6.
with glass thickness increase, the antenna resonant frequency shifted downwards by 40 MHz per 0.5 mm thickness increase, and there is a gain drop when the thickness is more than 4 mm. However, a larger ground plane was found to prevent this behaviour in other simulations.
with a ground plane area increase, the antenna efficiency and gain both improved.

FIG. 10 is an S11 graph showing the effect of changing the internal angle between the ground plane 24 and the radiator arrangement 20 from 90 degrees and 120 degrees, to simulate a raked windshield. The graph shows the antenna operating bandwidth is not substantially affected by changing the internal angle between the ground plane 24 and the radiator 20.

It will be appreciated that various changes and modifications can be made to the present invention without departing from the scope of the present application.

Although embodiments of the present invention have been described in the preceding paragraphs with reference to various examples, it should be appreciated that modifications to the examples given can be made without departing from the scope of the invention as claimed. Depending on the number of frequency bands to be supported, it would be appreciated that some aspects can be omitted or changed. In some examples, the slot 212 could be omitted. In some examples, the fold 210 could be omitted. In some examples, only one branch is required.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A vehicle antenna apparatus comprising:
a feed point; and
a radiator arrangement configured to be integrated with vehicle glazing;
wherein the radiator arrangement comprises a branch configured to resonate in a first operational frequency band.

2. The vehicle antenna apparatus of claim 1, comprising circuitry configured to operate the vehicle antenna apparatus as a transceiver or as a transmitter, wherein the circuitry is configured to electrically connect to the radiator arrangement via the feed point and is configured to electrically connect to a ground plane that is not integrated with the vehicle glazing.

3. The vehicle antenna apparatus of claim 1, wherein the first operational frequency band is at least 0.6 GHz.

4. The vehicle antenna apparatus of claim 1, wherein the radiator arrangement is a planar radiator arrangement.

5. The vehicle antenna apparatus of claim 1, comprising an adhesive patch, the adhesive patch comprising the radiator arrangement.

6. The vehicle antenna apparatus of claim 1, wherein the radiator arrangement comprises a column and the branch together forming a T-shape.

7. The vehicle antenna apparatus of claim 1, wherein the branch comprises an inner branch and an outer branch.

8. The vehicle antenna apparatus of claim 7, wherein the radiator arrangement comprises a slot shaped to demarcate the branch into the inner branch and the outer branch.

9. The vehicle antenna apparatus of claim 1, wherein the branch is a first branch and wherein the vehicle antenna apparatus comprises a second branch configured to resonate in a second operational frequency band.

10. The vehicle antenna apparatus of claim 9, wherein the branch is distal from the feed point and wherein the second branch is proximal to the feed point.

11. The vehicle antenna apparatus of claim 9, wherein the second branch is towards an opposite end of the column of claim 9 or 10 than the first branch.

12. The vehicle antenna apparatus of claim 2, wherein the second branch is folded.

13. A system comprising the vehicle antenna apparatus of claim 1, and a vehicle glazing panel comprising the radiator arrangement of the vehicle antenna apparatus.

14. The system of claim 13, wherein the vehicle glazing panel comprises a reflective layer configured to cover a substantial portion of the vehicle glazing panel to reflect infrared radiation, wherein the reflective layer comprises a gap around the location of the vehicle antenna apparatus.

15. A vehicle comprising the vehicle antenna apparatus of claim 1.

16. The vehicle of claim 15, wherein the ground plane is oriented approximately along a vehicle body panel, wherein the radiator arrangement extends along the vehicle glazing panel, the vehicle glazing panel being at a rake angle relative to the vehicle body panel such that an internal angle between the radiator arrangement and the ground plane is greater than 90 degrees.

17. A vehicle comprising the system of claim 13.

18. The vehicle antenna apparatus of claim 5, wherein the adhesive patch and the radiator arrangement are configured to be flexible enough to enable the radiator arrangement to be coplanar with curved vehicle glazing.

19. The vehicle antenna apparatus of claim 8, wherein the slot is a closed slot so that the inner branch is electrically connected to the outer branch.

20. The system of claim 13, wherein the vehicle glazing panel is laminated, and wherein the radiator arrangement is laminated between glazing layers of the laminated vehicle glazing panel.
